(19) United States
(12) Patent Application Publication
(10) Pub. No.: US 2016/0259196 A1
(43) Pub. Date: Sep. 8, 2016

(54) LIQUID CRYSTAL DISPLAY PANEL AND METHOD FOR MANUFACTURING THE SAME

(71) Applicant: Shenzhen China Star Optoelectronics Technology Co., Ltd., Shenzhen City, Guangdong (CN)

(72) Inventor: Hua ZHENG, Shenzhen, Guangdong (CN)

(73) Assignee: Shenzhen China Star Optoelectronics Technology Co., Ltd., Shenzhen City, Guangdong (CN)

(21) Appl. No.: 14/406,213

(22) PCT Filed: Oct. 13, 2014
(86) PCT No.: PCT/CN2014/088487

§ 371 Date: Dec. 6, 2014

(30) Foreign Application Priority Data
Oct. 10, 2014 (CN) 201410531248.0

(51) Int. Cl. G02F 1/1339; G02F 1/1335

(52) U.S. Cl. CPC G02F 1/13394; G02F 1/133514; G02F 2001/13396

(57) ABSTRACT

The present invention provides a liquid crystal display panel and method for manufacturing the same. The method for manufacturing the liquid crystal display panel comprises: coating a photoresist layer on a base; exposing the photoresist layer through a mask so as to form a spacing layer with a height that is varied, wherein the height of the spacing layer is decreased successively along a direction extended from a middle area of the liquid crystal display panel to a two-side area of the liquid crystal display panel; and removing the photoresist being exposed. By the method provided above, the present invention makes the brightness displayed by the liquid crystal display panel be uniform such that the two-side whitening occurred while displaying by the liquid crystal display panel can be reduced or eliminated.

### FIELD OF THE INVENTION

The present invention relates to a technique field of liquid crystal display panel, and more particularly to liquid crystal display panel and method for manufacturing the same.

### BACKGROUND OF THE INVENTION

When a TFT-LCD (Thin Film Transistor-Liquid Crystal Display) panel displays a low grey level image, there usually appears a poor display quality, so called as a two-side whitening, wherein the brightness in two-side area of the TFT-LCD is high and the brightness in the middle area of the TFT-LCD is low.

The reason why the two-side whitening occurred is that, as shown in FIG. 1, the driving voltage of the Gate line 11 is input from the scan driving electrode (Gate COF) 12 on the left and right side of the liquid crystal display panel 10, and the resistor R and capacitor C of the Gate line 11 results in RC delay, such that the voltage normally input from the two sides is distorted when it is transmitted to the middle area A, i.e. the Gate wave is distorted. The distorted voltage would reduce the charging ratio in the middle area A so that the brightness at the middle area A is lowered. At this time, the brightness at the two-side areas B1 and B2 is higher than the brightness at the middle area A, i.e. the two-side whitening occurs. The two-side whitening is more obviously when displaying a low grey level image due to sensitivity of human eyes.

### SUMMARY OF THE INVENTION

Accordingly, the technique solution to be solved by the embodiments of the present invention is to provide a liquid crystal display panel and method for manufacturing the same, such that the brightness displayed by the liquid crystal display panel could be uniform and the two-side whitening occurred while displaying by the liquid crystal display panel can be reduced or eliminated.

In order to solve the above mentioned technique problem, a technique solution adopted by the present invention is to provide a method for manufacturing a liquid crystal display panel, which comprises: coating a photoresist layer on a base; exposing the photoresist layer through a mask so as to form a spacing layer with a height that is varied, and, at the same time, controlling a first horizontal shifting speed of a first baffle and a second horizontal shifting speed of a second baffle so as to successively increase an exposing time for exposing the photoresist layer along a direction extended from a middle area to a two-side area, wherein the first baffle and the second baffle are opaque and disposed between the mask and a light source used for exposing, wherein the height of the spacing layer is decreased successively along the direction extended from the middle area of the liquid crystal display panel to the two-side area of the liquid crystal display panel, the spacing layer comprises a plurality of photo spacers, and, along the direction extended from the middle area to the two-side area, the photo spacers are with an identical maximum width; and removing the photoresist layer being exposed.

Wherein, the exposing time for exposing the photoresist layer satisfies the equation as follows:

$$T ( x ) = {T}_{max} + {\int }_{0}^{x} [ \frac{1}{V 2 ( x )} - \frac{1}{V 1 ( x )} ] d x$$

wherein, T(x) is the exposing time, V1(x) is the first horizontal shifting speed of the first baffle, V2(x) is the second horizontal shifting speed of the second baffle, x is an exposing position, and Tₘₐₓ is a maximum exposing time at the exposing position.

Wherein, an area of the first baffle and the second baffle is greater than or equals to the area of the liquid crystal display panel.

Wherein, a manufacturing material of the photoresist layer comprises a positive photoresist material.

Wherein, a developing technique is applied for removing the photoresist layer being exposed.

Wherein, the base is correspondence to a color filter substrate for forming the liquid crystal display panel.

In order to solve the above mentioned technique problem, another technique solution adopted by the present invention is to provide a method for manufacturing a liquid crystal display panel, which comprises: coating a photoresist layer on a base; exposing the photoresist layer through a mask so as to form a spacing layer with a height that is varied, wherein the height of the spacing layer is decreased successively along a direction extended from a middle area of the liquid crystal display panel to a two-side area of the liquid crystal display panel; and removing the photoresist being exposed.

Wherein, at the same time while exposing the photoresist layer through the mask, the method further comprises: controlling a first horizontal shifting speed of a first baffle and a second horizontal shifting speed of a second baffle so as to successively increase an exposing time for exposing the photoresist layer along the direction extended from the middle area to the two-side area, wherein the first baffle and the second baffle are opaque and disposed between the mask and a light source used for exposing.

Wherein, the exposing time for exposing the photoresist layer satisfies the equation as follows:

$$T ( x ) = {T}_{max} + {\int }_{0}^{x} [ \frac{1}{V 2 ( x )} - \frac{1}{V 1 ( x )} ] d x$$

wherein, T(x) is the exposing time, V1(x) is the first horizontal shifting speed of the first baffle, V2(x) is the second horizontal shifting speed of the second baffle, x is an exposing position, and Tₘₐₓ is a maximum exposing time at the exposing position.

Wherein, an area of the first baffle and the second baffle is greater than or equals to the area of the liquid crystal display panel.

Wherein, the spacing layer comprises a plurality of photo spacers, and, along the direction extended from the middle area to the two-side area, the photo spacers are with an identical maximum width.

Wherein, a manufacturing material of the photoresist layer comprises a positive photoresist material.

Wherein, a developing technique is applied for removing the photoresist layer being exposed.

Wherein, the base is correspondence to a color filter substrate for forming the liquid crystal display panel.

In order to solve the above mentioned technique problem, the other technique solution adopted by the present invention is to provide a liquid crystal display panel, which comprises a base and a plurality of photo spacers with different heights, wherein the heights of the photo spacers are decreased successively along a direction extended from a middle area of the liquid crystal display panel to a two-side area of the liquid crystal display panel.

Wherein, the base is a color filter substrate of the liquid crystal display panel.

Wherein, a spacing layer comprises the photo spacers, and, along the direction extended from the middle area to the two-side area, the photo spacers are with an identical maximum width.

Through the above mentioned technique solution, the benefit caused by the embodiments of the present invention is that the embodiments of the present invention forms a spacing layer with decreasing height along the direction extended from the middle area to the two-side areas of the liquid crystal display panel such that a depth of a liquid crystal layer at the two-side areas is less than the depth of the liquid crystal layer at the middle area. Because the liquid crystal efficiency at the two-side areas would be reduced due to decrease of the depth of the liquid crystal layer, the transmittance of the pixel units in two-side areas would be reduced so as to reduce the displayed brightness at the two-side areas. At this time, the brightness difference between the two-side areas and the middle area could be reduced or eliminated, the liquid crystal display panel displays uniform brightness, and the two-side whitening can be reduced or eliminated.

### BRIEF DESCRIPTION OF THE DRAWINGS

FIG. 1 is a structure top view of a conventional liquid crystal display panel.

FIG. 2 is a flow chart of a method for manufacturing a liquid crystal display panel according to a preferred embodiment of the present invention.

FIG. 3 is a schematic diagram showing a first scene wherein the exposure is performed according to a preferred embodiment of the present invention.

FIG. 4 is a schematic diagram showing the relationship between the exposing position and the exposing time shown in FIG. 3.

FIG. 5 is a schematic diagram showing a second scene wherein the exposure is performed according to a preferred embodiment of the present invention.

FIG. 6 is a schematic diagram showing a third scene wherein the exposure is performed according to a preferred embodiment of the present invention.

FIG. 7 is a schematic diagram showing a first relationship between the first horizontal shifting speed of the first baffle, the second horizontal shifting speed of the second baffle and the exposing position shown in FIG. 6.

FIG. 8 is a schematic diagram showing a second relationship between the first horizontal shifting speed of the first baffle, the second horizontal shifting speed of the second baffle and the exposing position shown in FIG. 6.

FIG. 9 is a schematic diagram showing a third relationship between the first horizontal shifting speed of the first baffle, the second horizontal shifting speed of the second baffle and the exposing position shown in FIG. 6.

FIG. 10 is a schematic diagram showing a fourth relationship between the first horizontal shifting speed of the first baffle, the second horizontal shifting speed of the second baffle and the exposing position shown in FIG. 6.

FIG. 11 is a cross-sectional view of a color filter substrate produced by applying the method shown in FIG. 2.

FIG. 12 is a cross-sectional view of a liquid crystal display panel having the color filter substrate shown in FIG. 11.

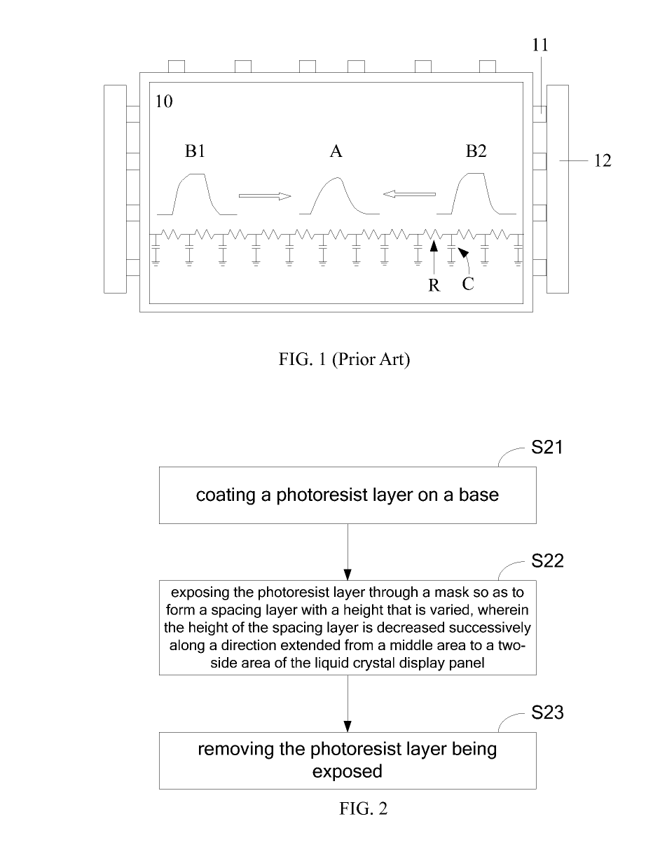

### DETAILED DESCRIPTION OF PREFERRED EMBODIMENTS

The technique solutions in the embodiments of the present invention are described clearly and completely below with reference to the attached drawings of the embodiments of the present invention. Obviously, the embodiments described below are a part of embodiments but not all embodiments of the present invention. All other embodiments obtained by those have ordinary skill in the field based on the embodiments of the present invention without creative effort are within the protection scope of the present invention.

FIG. 2 is a flow chart of a method for manufacturing a liquid crystal display panel according to a preferred embodiment of the present invention. As shown in FIG. 2, the method for manufacturing a liquid crystal display according to the present embodiment comprises the steps of:

Step S21: coating a photoresist layer on a base.

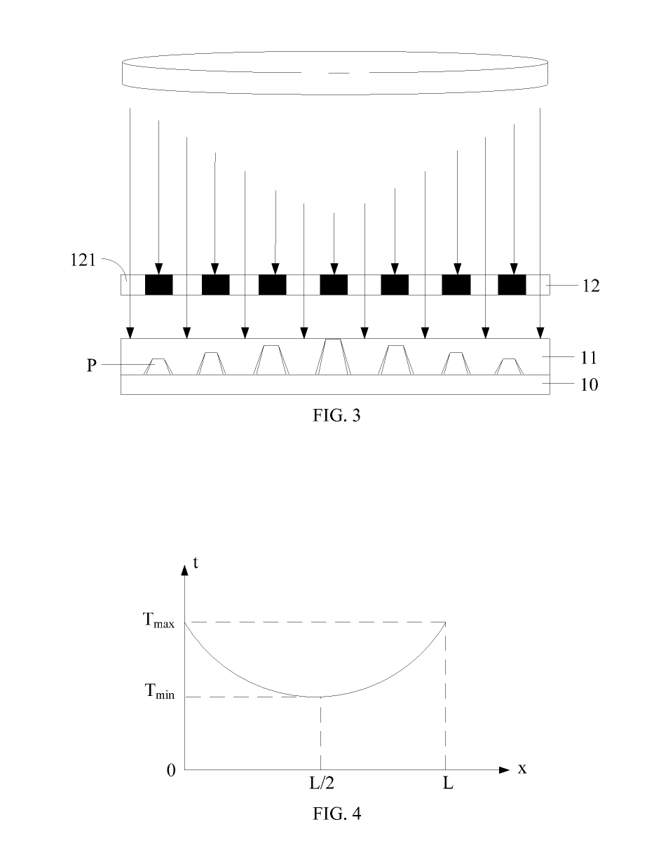

Refer with FIG. 3, the base 10, which could be a glass base, a plastic base or a flexible base, is correspondence to a color filter substrate used for forming the liquid crystal display panel. A manufacturing material of the photoresist layer 11 is a positive photoresist material, and is preferably coated uniformly on the base 10.

Step S22: exposing the photoresist layer through a mask so as to form a spacing layer with a height that is varied, wherein the height of the spacing layer is decreased successively along a direction extended from a middle area to a two-side area of the liquid crystal display panel.

As shown in FIG. 3, there are a plurality of transparent regions 121 with identical transmittance on the mask 12. The amount of the transparent regions 12 is for illustration only. Preferably, in the present embodiment, the widths of the transparent regions 121 and the distances between two neighbored transparent regions 121 are identical.

Preferably, the mask 12 in the present embodiment equals to the patterned mask for manufacturing photo spacer (PS) in the conventional technique, and the manufacturing process could be: performing a mark process at the area where the photo spacer is on the liquid crystal display panel, firstly; after that, a plurality of transparent regions 121 are defined on a mask base according to the marks, wherein the mask base is preferably a transparent hard material, such as glass or quartz, and the surface thereof is coated by an opaque metal layer, such as Cr, Al, Cu, Mo etc. and/or alloy film of these metals or combination of some of them; finally, the opaque layer corresponding to each first transparent region 121 is etched, and the proceeded processing, such as washing, etc. is performed so that the mask 12 is produced.In order to ensure the exposure region during exposing, the mask base is preferably selected such that the area of mask 12 is greater than or equals to the area of the liquid crystal display panel.

The main object of the embodiment of the present invention is to form a spacing layer having a plurality of photo spacers P with different heights on the base 10, and, along a direction extended from the middle area to the two-side areas, the heights of the photo spacers P are successively decreased. Based on that, it is preferably to control the exposure energy on different regions of the photoresist layer 11 such that the exposure energy is successively increased along the direction extended from the middle area to the two-side areas in order to obtain the photo spacers P having different heights.

Because the light intensity (exposure energy) is identical in an exposure unit, the exposing time for different region of the photoresist layer 11 should be controlled such that, along the direction extended from the middle area to the two-side areas, the exposing time is increased successively. Refer with FIG. 4, the abscissa axis is an exposing position x, the ordinate axis is the exposing time t, wherein Tₘₐₓ is the exposing time at the exposing position x=0 and x=L, Tₘₐₓ is the longest exposing time during the exposing process and is correspondence to the exposing time at the two-side areas, Tₘᵢₙ is the exposing time for the exposing position x=L/2, and Tₘᵢₙ is the shortest exposing time during the exposing process and is correspondence to the exposing time for the middle area, wherein L is the length of the photoresist layer 11 or the length of the whole liquid crystal display panel.

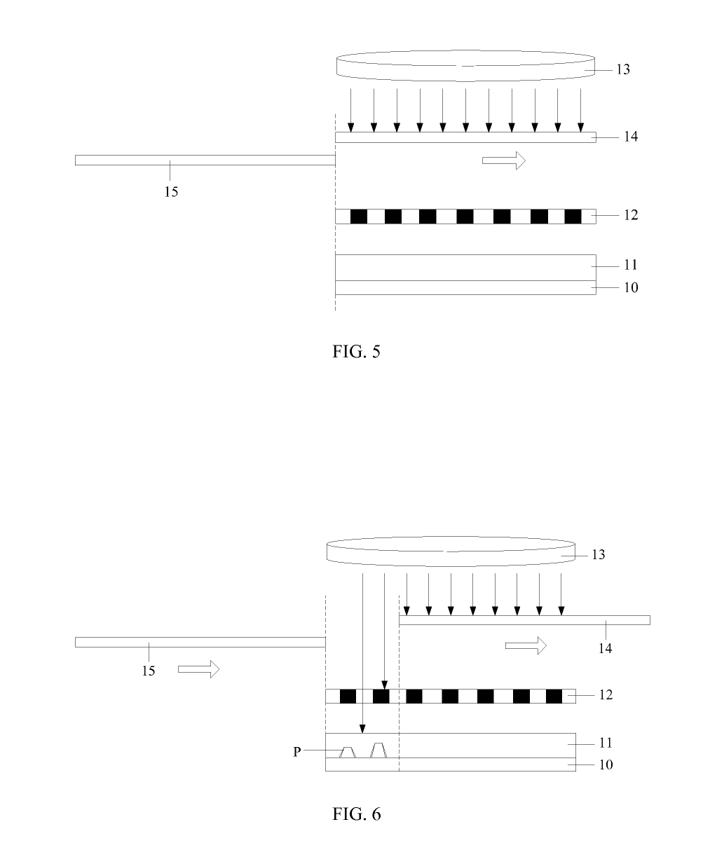

Preferably, the opaque first baffle 14 and second baffle 15 are disposed in the exposure unit in the present embodiment as shown in FIG. 5 and FIG. 6 so as to control the exposing time for the photoresist layer 11. The process for manufacturing the photo spacers P of the spacing layer is described by combining reference to FIG. 5 and FIG. 6 as follows:

Please refer to FIG. 5, the base 10 coated by the photoresist layer 11 is disposed in the exposure unit, the mask 12 is disposed between light source 13 and the photoresist layer 11, and the first baffle 14 and the second baffle 15 are disposed between the mask 12 and the light source 13. Wherein, the first baffle 14 and the second baffle 15 is made by opaque hard materials, such as metal or alloy materials, which is steel, copper, etc. or non-metal materials, which is plastic, ceramic, etc. The area of each baffle is greater than or equals to the area of the liquid crystal display panel, i.e. greater than or equals to the area of the base 10. Preferably, the vertical related positions of the first baffle 14 and the second baffle 15 in the present embodiment is that, along a direction vertical to the base 10, the first baffle 14 is disposed between the second baffle 15 and the light source 13.

At this time, the transparent regions 121 on the mask 12 are aligned with the regions where the photo spacers P are going to be formed on the base 10. After that, the light source 13 is turned on for performing exposure. Preferably, the light source 13 is an UV (Ultraviolet) source, and a light for exposing is with the exposure energy E. The range of the exposure energy E is determined according to the characteristic of the materials of the positive photoresist layer 11, and, in the present embodiment, the range of the exposure energy E is preferably 1˜100 mJ/cm² (milli-Joule per centimeter squared).

During the exposing process, the present embodiment makes the exposing time be increased successively along the direction extended from the middle area to the two-side areas through controlling a first horizontal shifting speed of the first baffle 14 and a second horizontal shifting speed of the second baffle 15.

Specifically, as shown in FIG. 5, the left edge of the first baffle 14 is the initial exposing position x=0, the first baffle 14 is activated at the initial exposing time t=0 and moves to right in the first horizontal shifting speed V1(x) along the direction illustrated by the arrow in the figure. At this time, the time when any exposing position x on the photoresist layer 11 begins to be exposed is the time t when the left edge of the first baffle 14 reaches to the exposing position, and the equation 1-1 should be satisfied as follows:

$$t = {T}_{start} = {\int }_{0}^{x} \frac{1}{V 1 ( x )} d x \qquad equation 1 \text{-} 1$$

Wherein, Tₛₜₐᵣₜ is the time when the exposing position x begins to be exposed.

As shown in FIG. 6, the right edge of the second baffle 15 is the initial exposing position x=0, the second baffle 15 is activated at the initial exposing time t=Tₘₐₓ and moves to right in the second horizontal shifting speed V2(x) along the direction illustrated by the arrow in the figure. At this time, the time when any exposing position x on the photoresist layer 11 stopsbeing exposed is the time t when the right edge of the second baffle 15 reaches to the exposing position, and the equation 1-2 should be satisfied as follows:

$$t = {T}_{end} = {T}_{max} + {\int }_{0}^{x} \frac{1}{V 2 ( x )} d x \qquad equation 1 \text{-} 2$$

Wherein, T_{end} is the time when the exposing position x stops being exposed.

Combining equation 1-1 and equation 1-2, the exposing time for any exposing position x can be obtained by T(x)=T_{end}−Tₛₜₐᵣₜ, and the T(x) satisfies the equation 1-3:

$$T ( x ) = {T}_{max} + {\int }_{0}^{x} [ \frac{1}{V 2 ( x )} - \frac{1}{V 1 ( x )} ] d x \qquad equation 1 \text{-} 3$$

Applying mathematical exchange on equation 1-3, equation 1-4 could be obtained as follow:

$$\frac{1}{V 2 ( x )} - \frac{1}{V 1 ( x )} = \frac{d T ( x )}{d x} \qquad equation 1 \text{-} 4$$

Accordingly, it can be known that, no matter how the shape of a curve corresponding to the exposing time t shown in FIG. 4 is a value of a first horizontal shifting speed V1(x) and second horizontal shifting speed V2(x) which satisfies equation 1-3 and equation 1-4 can be obtained through calculation always.

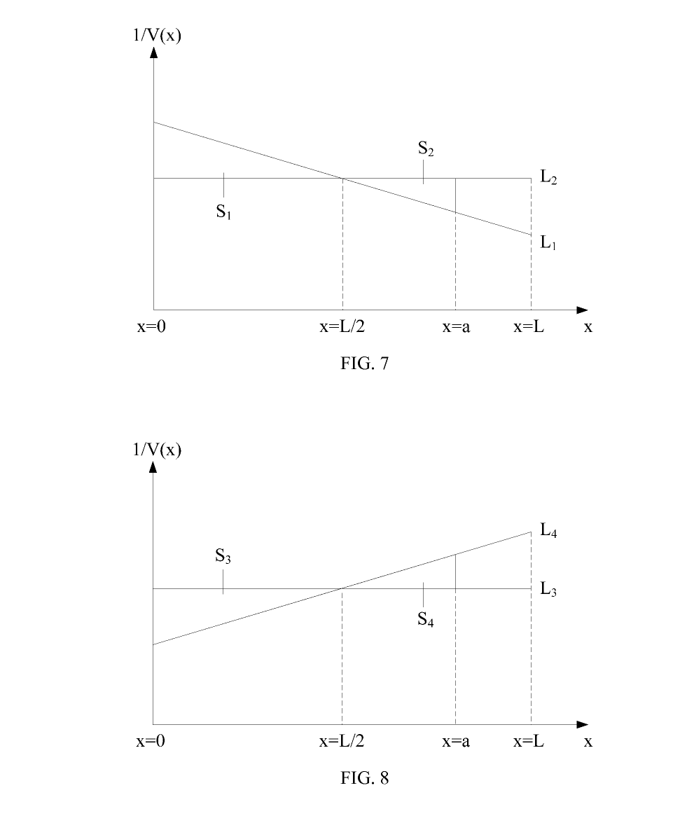

For example, when the curve corresponding to the exposing time t is the quadratic curve shown in FIG. 4, a reciprocal curve of the first horizontal shifting speed V1(x) and the second horizontal shifting speed V2(x) corresponding to different exposing positions of the first baffle 14 and the second baffle 15 are the straight lines shown in FIG. 7 or FIG. 8.

Refer to FIG. 7 and FIG. 8, the abscissa axis represents a reciprocal 1/V(x) of the horizontal shifting speed, the ordinate axis represents the exposing position x, the straight line L₁ represents the reciprocal 1/V1(x) of the horizontal shifting speed V1(x) when the first baffle 14 speeds up the horizontal shifting and the second baffle 15 horizontally shifts in a constant speed, the straight line L₂ represents the reciprocal 1/V2(x) of the horizontal shifting speed V2(x) when the first baffle 14 speeds up the horizontal shifting and the second baffle 15 horizontally shifts in a constant speed,the straight line L₃ representsthe reciprocal 1/V1(x) of the horizontal shifting speed V1(x) when the first baffle 14 horizontally shifts in a constant speed and the second baffle 15 slowsdownthe horizontal shifting, and the straight line L₄ represents the reciprocal 1/V2(x) of the horizontal shifting speed V2(x) when the first baffle 14 horizontally shifts in a constant speed and the second baffle 15 slows down the horizontal shifting.

Combining equation 1-3 and equation 1-4, it can be known that a corresponded exposing time T(a)=Tₘₐₓ+S₂−S₁ at the exposing position where x=a when the first baffle 14 speeds up the horizontal shifting and the second baffle 15 horizontally shifts in a constant speed as shown in FIG. 7; and a corresponded exposing time T(a)=Tₘₐₓ+S₄−S₃ at the exposing position where x=a when the first baffle 14 horizontally shifts in a constant speed and the second baffle 15 slows down the horizontally shifting as shown in FIG. 8. Wherein, S2−S1 and S4−S3 is calculus of difference between the reciprocal 1/V2(x) of the corresponded second horizontal shifting speed V2(x) and the reciprocal 1/V1(x) of the corresponded first horizontal shifting speed V1(x).

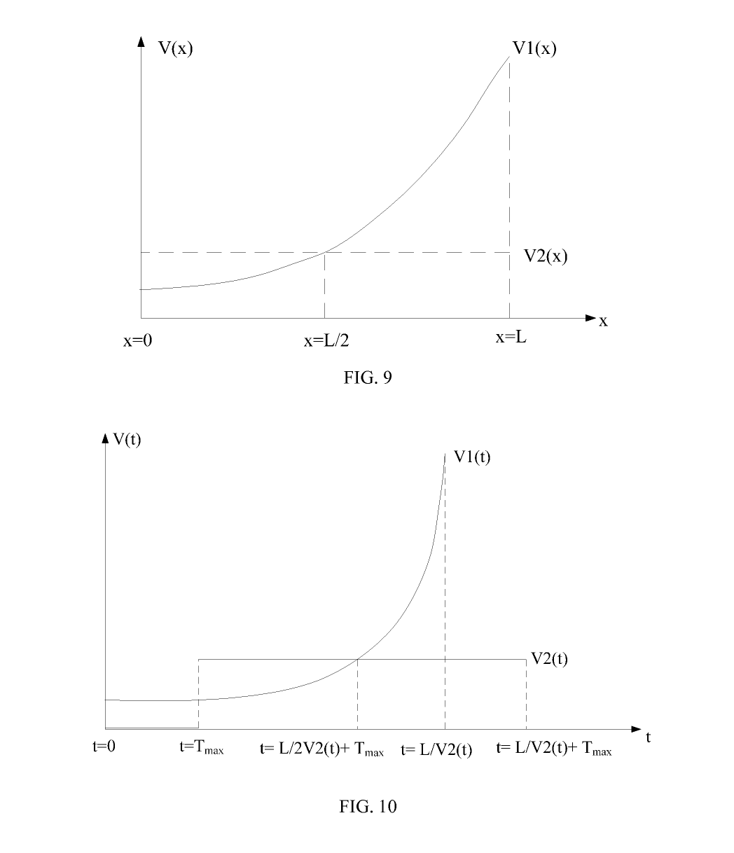

Intuitively, the schematic diagram showing a third relationship between the exposing position x, the first horizontal speed V1(x) and the second horizontal speed V2(x) shown in FIG. 9 can be obtained according to the schematic diagram showing a first relationship between the exposing position x, the reciprocal 1/V1(x) and the reciprocal 1/V2(x) shown in FIG. 7. For the same reason, the schematic diagram showing a fourth relationship between the horizontal shifting time t, the first horizontal speed V1(t) (i.e. V1(x)) and the second horizontal speed V2(t) (i.e. V2(x)) shown in FIG. 10 can be obtained according to the schematic diagram showing a second relationship between the exposing position x, the reciprocal 1/V1(x) and the reciprocal 1/V2(x) shown in FIG. 7.

According to the description made above, when the values of the first horizontal shifting speed V1(x) and the second horizontal shifting speed V2(x) satisfying the equation 1-3 and equation 1-4 are obtained, the reciprocal curves corresponding to the first horizontal shifting speed V1(x) and second horizontal shifting speed V2(x) could be in any shape, i.e. there are countless value sets of the first horizontal shifting speed V1(x) and second horizontal shifting speed V2(x).

Step S23: removing the photoresist layer being exposed.

After completing the steps mentioned above, the photoresist layer 11 being exposed in removed by developing techniques.

At this time, because the heights of the photo spacers P are successively decreased along the direction extended from the middle area to the two-side areas of the liquid crystal display panel such that the depths of the liquid crystal layer at the two-side areas are smaller than the depths of the liquid crystal layer at the middle area, it can be known from the public knowledge, of which the transmittance of a pixel unit=aperture ratio*liquid efficiency, in the field of liquid crystal display that the liquid efficiency at the two-side areas is reduced due to the decreased depth of the liquid crystal layer and therefore the transmittances of the pixel units at the two-side areas are reduced, such that the brightness at the two-side areas is reduced. At this time, the brightness difference between the two-side areas and the middle area could be reduced or eliminated, the liquid crystal display panel displays uniform brightness, and the two-side whitening can be reduced or eliminated.

In the embodiment, the heights of the photo spacers P are determined by the material characteristics of the liquid crystal. Take Merck 718 liquid crystal as an example, the height of the photo spacer is 2.5 um in the conventional technique while the height of the photo spacer P is 2.0 um at the two-side areas and the height of the photo spacer P is 3.0 um at the middle area in the embodiments of the present invention. Besides, the first baffle 14 and second baffle 15 could be disposed on a pulley or guide rail and the horizontal shifting speeds thereof could be controlled by an automatic driving apparatus, such that the movement in a single direction with varied speeds could be realized, and, preferably, a range of the speed is 1˜3000 mm/sec.

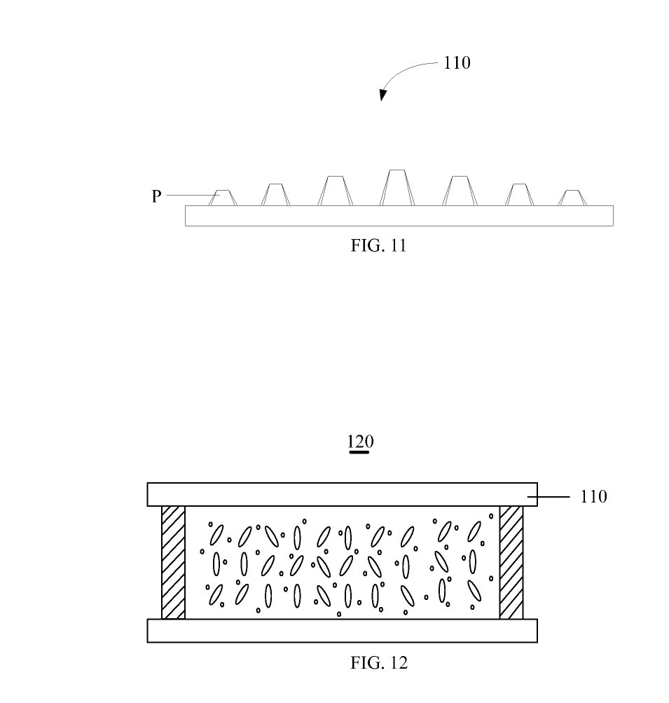

The embodiments of the present invention further provide a color filter substrate 110 shown in FIG. 11, which is made by applying the manufacturing method described above, and a liquid crystal display panel 120 shown in FIG. 12, which comprises the color filter substrate 110, and therefore provide the same technique effects.

In summary, the embodiments of the present invention forms a spacing layer with decreasing height along the direction extended from the middle area to the two-side areas of the liquid crystal display panel such that a depth of a liquid crystal layer at the two-side areas is less than the depth of the liquid crystal layer at the middle area. Because the liquid crystal efficiency at the two-side areas would be reduced due to decrease of the depth of the liquid crystal layer, the transmittance of the pixel units in two-side areas would be reduced so as to reduce the displayed brightness at the two-side areas. At this time, the brightness difference between the two-side areas and the middle area could be reduced or eliminated, the liquid crystal display panel displays uniform brightness, and the two-side whitening can be reduced or eliminated.

It is again noted that, the descriptions made above are the embodiments of the present invention, and are not used for limiting the protection scope of the present invention. All equivalent structures or process variations made according to the contents of the specification and attached drawings of the present invention, such as combining technique features of the embodiments or applying, either directly or indirectly, them into other related technique fields, are included in the patent protection scope of the present invention.

What is claimed is:

1. A method for manufacturing a liquid crystal display panel, wherein the method comprises:
coating a photoresist layer on a base;
exposing the photoresist layer through a mask so as to form a spacing layer with a height that is varied, and, at the same time, controlling a first horizontal shifting speed of a first baffle and a second horizontal shifting speed of a second baffle so as to successively increase an exposing time for exposing the photoresist layer along a direction extended from a middle area to a two-side area, wherein the first baffle and the second baffle are opaque and disposed between the mask and a light source used for exposing, wherein the height of the spacing layer is decreased successively along the direction extended from the middle area of the liquid crystal display panel to the two-side area of the liquid crystal display panel, the spacing layer comprises a plurality of photo spacers, and, along the direction extended from the middle area to the two-side area, the photo spacers are with an identical maximum width; and
removing the photoresist layer being exposed.

2. The method according to claim 1, whereinthe exposing time for exposing the photoresist layer satisfies the equation as follows:
$$T ( x ) = {T}_{max} + {\int }_{0}^{x} [ \frac{1}{V 2 ( x )} - \frac{1}{V 1 ( x )} ] d x$$
wherein, T(x) is the exposing time, V1(x) is the first horizontal shifting speed of the first baffle, V2(x) is the second horizontal shifting speed of the second baffle, x is an exposing position, and Tₘₐₓ is a maximum exposing time at the exposing position.

3. The method according to claim 1, wherein an area of the first baffle and the second baffle is greater than or equals to the area of the liquid crystal display panel.

4. The method according to claim 1, wherein a manufacturing material of the photoresist layer comprises a positive photoresist material.

5. The method according to claim 4, wherein a developing technique is applied for removing the photoresist layer being exposed.

6. The method according to claim 1, wherein the base is correspondence to a color filter substrate for forming the liquid crystal display panel.

7. A method for manufacturing a liquid crystal display panel, wherein the method comprises:
coating a photoresist layer on a base;
exposing the photoresist layer through a mask so as to form a spacing layer with a height that is varied, wherein the height of the spacing layer is decreased successively along a direction extended from a middle area of the liquid crystal display panel to a two-side area of the liquid crystal display panel; and
removing the photoresist being exposed.

8. The method according to claim 7, wherein at the same time while exposing the photoresist layer through the mask, the method further comprises:
controlling a first horizontal shifting speed of a first baffle and a second horizontal shifting speed of a second baffle so as to successively increase an exposing time for exposing the photoresist layer along the direction extended from the middle area to the two-side area, wherein the first baffle and the second baffle are opaque and disposed between the mask and a light source used for exposing.

9. The method according to claim 8, wherein the exposing time for exposing the photoresist layer satisfies the equation as follows:
$$T ( x ) = {T}_{max} + {\int }_{0}^{x} [ \frac{1}{V 2 ( x )} - \frac{1}{V 1 ( x )} ] d x$$
wherein, T(x) is the exposing time, V1(x) is the first horizontal shifting speed of the first baffle, V2(x) is the second horizontal shifting speed of the second baffle, x is an exposing position, and Tₘₐₓ is a maximum exposing time at the exposing position.

10. The method according to claim 8, wherein an area of the first baffle and the second baffle is greater than or equals to the area of the liquid crystal display panel.

11. The method according to claim 7, wherein the spacing layer comprises a plurality of photo spacers, and, along the direction extended from the middle area to the two-side area, the photo spacers are with an identical maximum width.

12. The method according to claim 7, wherein a manufacturing material of the photoresist layer comprises a positive photoresist material.

13. The method according to claim 12, wherein a developing technique is applied for removing the photoresist layer being exposed.

14. The method according to claim 7, wherein the base is correspondence to a color filter substrate for forming the liquid crystal display panel.

15. A liquid crystal display panel, wherein the liquid crystal display panel comprises a base and a plurality of photo spacers with different heights, wherein the heights of the photo spacers are decreased successively along a direction extended from a middle area of the liquid crystal display panel to a two-side area of the liquid crystal display panel.

16. The liquid crystal display panel according to claim 15, wherein the base is a color filter substrate of the liquid crystal display panel.

17. The liquid crystal display panel according to claim 15, wherein a spacing layer comprises the photo spacers, and, along the direction extended from the middle area to the two-side area, the photo spacers are with an identical maximum width.
